(19) United States
(12) Patent Application Publication
(10) Pub. No.: US 2013/0145677 A1
(43) Pub. Date: Jun. 13, 2013

(54) FISH FINDER APPARATUS

(71) Applicant: Robert Bowden, Hoboken, NJ (US)

(72) Inventor: Robert Bowden, Hoboken, NJ (US)

(21) Appl. No.: 13/313,137

(22) Filed: Dec. 7, 2011

(51) Int. Cl. A01K 97/12

(52) U.S. Cl. 43/44.92

(57) ABSTRACT

According to an embodiment of the present invention, an improved fish finder apparatus is provided that allows for the apparatus to be attached to and removed from a fishing line without need to cut said fishing line. This is achieved by providing an improved fish finder apparatus with a channel for receiving fishing line, thread or other filamentous material. One of ordinary skill in the art would appreciate that any type of fishing line, thread, or other filamentous material could be used with embodiments of the present invention, and embodiments of the present invention are contemplated for use with any fishing line, thread or other filamentous material.

### FIELD OF THE INVENTION

The present invention generally relates to fish finders. Specifically, this invention relates to an improved fish finder apparatus is provided that allows for the apparatus to be attached to and removed from a fishing line without need to cut said fishing line.

### BACKGROUND OF THE INVENTION

The use of fish finders to weight fishing line is a common practice. However, all currently available fish finders require the user to tie otherwise affix the fishing line to the fish finder. In this manner, the only way to change this attachment later is to cut or otherwise damage the fishing line.

Additionally, since currently available fish finders are only attachable via affixing means that require cutting or severing of the fishing line, removal of a fish finder can be complicated and require additional tools (e.g., knife, scissors, pliers). In this manner, both the application and removal of the fish finder is a time consuming task.

Therefore, there is a need in the art for a fish finder apparatus that can be quickly and easily attached to fishing line or other filamentous material without requiring additional tools and can be removed without damaging the fishing line or other filamentous material. These and other features and advantages of the present invention will be explained and will become obvious to one skilled in the art through the summary of the invention that follows.

### SUMMARY OF THE INVENTION

Accordingly, embodiments of the present invention generally relates to an improved fish finder apparatus that allows for the apparatus to be attached to and removed from a fishing line without need to cut said fishing line.

According to an embodiment of the present invention, an improved fish finder apparatus is comprised of a body portion. The body portion of the fish finder apparatus is comprised of a channel for receiving fishing line, thread or other filamentous material.

According to embodiments of the present invention, the channel is comprised of two sections. One of the two sections being an interior channel and the second section being an exterior channel. The exterior channel is comprised of one or more bends or turns. The interior channel is comprised of a hollow channel running through the length of the body portion of the apparatus.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a perspective view of a fish finder apparatus in accordance with an embodiment of the present invention;

FIG. 2 is a side view of a fish finder apparatus in accordance with an embodiment of the present invention;

FIG. 3 is a front view of a fish finder apparatus in accordance with an embodiment of the present invention;

FIG. 4 is a bottom view of a fish finder apparatus in accordance with an embodiment of the present invention;

FIG. 5 is a lower perspective view of a fish finder apparatus in accordance with an embodiment of the present invention; and

FIG. 6 is a perspective view of a fish finder apparatus in accordance with an alternate embodiment of the present invention.

### DETAILED DESCRIPTION

According to an embodiment of the present invention, an improved fish finder apparatus is provided that allows for the apparatus to be attached to and removed from a fishing line without need to cut said fishing line. This is achieved by providing an improved fish finder apparatus comprised of a body portion. The body portion is comprised of a channel for receiving fishing line, thread or other filamentous material. One of ordinary skill in the art would appreciate that any type of fishing line, thread, or other filamentous material could be used with embodiments of the present invention, and embodiments of the present invention are contemplated for use with any fishing line, thread or other filamentous material.

According to embodiments of the present invention, the channel is comprised of two sections, an interior channel and an exterior channel. The exterior channel is comprised of one or more bends or turns. The interior channel is comprised of a hollow channel running through the length of the body portion of the apparatus.

Each of the one or more bends or turns may be comprised of any angle, slope, sharpness. For instance, an exterior channel may be comprised of 4 right angles creating a squared channel. One of ordinary skill in the art would appreciate that any number of bends or turns could be used with embodiments of the present invention, and embodiments of the present invention are contemplated for use with any number of bends or turns.

The one or more bends or turns in the exterior channel allow for the apparatus to receive a fishing line when the fishing line is not taut, by way of manipulating the fishing line through the one or more bends or turns. After manipulating the fishing line through the exterior channel, the fishing line is received into the interior channel of the apparatus. Once the apparatus has received the fishing line into interior channel, the fishing line may be pulled taut. Once the fishing line is pulled taut, the fishing line can no longer be manipulated through the exterior channel and is therefore slidably attached to the fishing line.

According to embodiments of the present invention, the exterior channel may be tapered from the exterior edge of the apparatus to the interior edge abutting the interior channel. In this manner, the fishing line, once manipulated into the interior channel from the exterior channel, will have a more difficult time escaping the inner channel without assistance from a user.

According to embodiments of the present invention, the apparatus is further comprised of a component mounting section. The component mounting section allows for a user to attach one or more components to the apparatus. Components that may be attached to the apparatus include, but are not limited to, sinkers, lures, and light-emitting diodes (LEDs). One of ordinary skill in the art would appreciate that any number of components could be used with embodiments of the present invention, and embodiments of the present invention are contemplated for use with any component.

According to embodiments of the present invention, the apparatus may further be comprised of a means for sealing, closing or narrowing the exterior channel. The means for sealing, closing or narrowing the exterior channel may include, but are not limited to, rubber stoppers, one or more jointed sections on the apparatus body allowing for the closure of the exterior channel, slides, and crimping means. One of ordinary skill in the art would appreciate that there are numerous means that could be used to seal, close or narrow the exterior channel, and embodiments of the present invention are contemplated for use with any number of means for sealing, closing or narrowing the exterior channel. By sealing, closing or narrowing the exterior channel of the apparatus, the risk of a taut or non-taut fishing line escaping from the inner channel, by way of the exterior channel, is reduced.

The entire apparatus may be comprised of one or more materials. Materials the apparatus may be comprised of include, but are not limited to, rubber, plastic, metal and ceramic. One of ordinary skill in the art would appreciate that the apparatus could be comprised of any number of materials, and embodiments of the present invention are contemplated for use with any material.

According to embodiments of the present invention, the apparatus described in this application may be used for purposes other than quickly and safely attaching components to a fishing line. Embodiments of the present invention can be used for numerous applications, including, but not limited to, hanging signage from a string, rope or other filamentous material, and hanging laundry from a clothesline or other filamentous material. One of ordinary skill in the art would appreciate that embodiments of the present invention could be used in any situation where there is a need to attach or hang an object from a continuous strand of filamentous material, and embodiments of the present invention are contemplated for attaching or hanging any object from any continuous strand of filamentous material.

### EXEMPLARY EMBODIMENTS

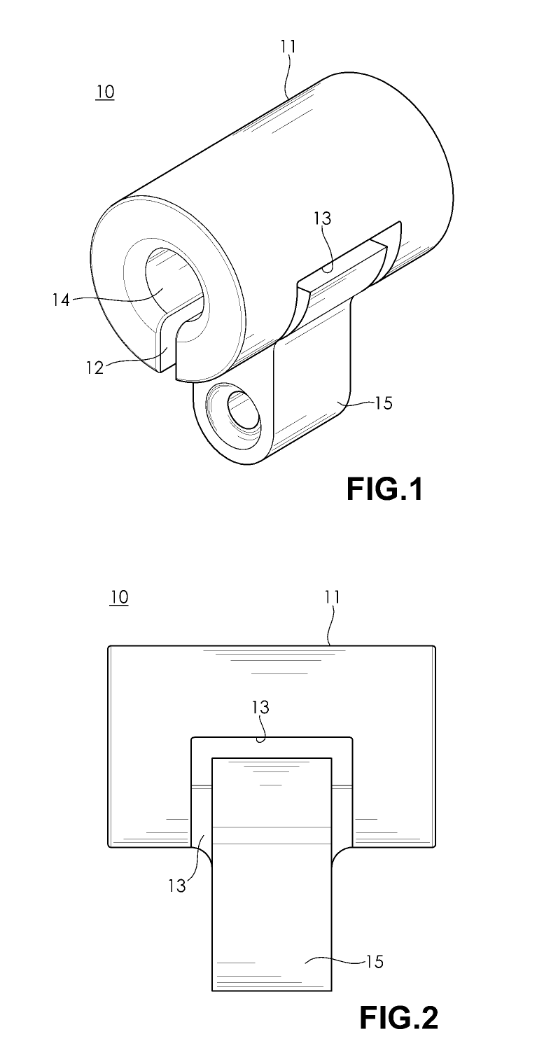

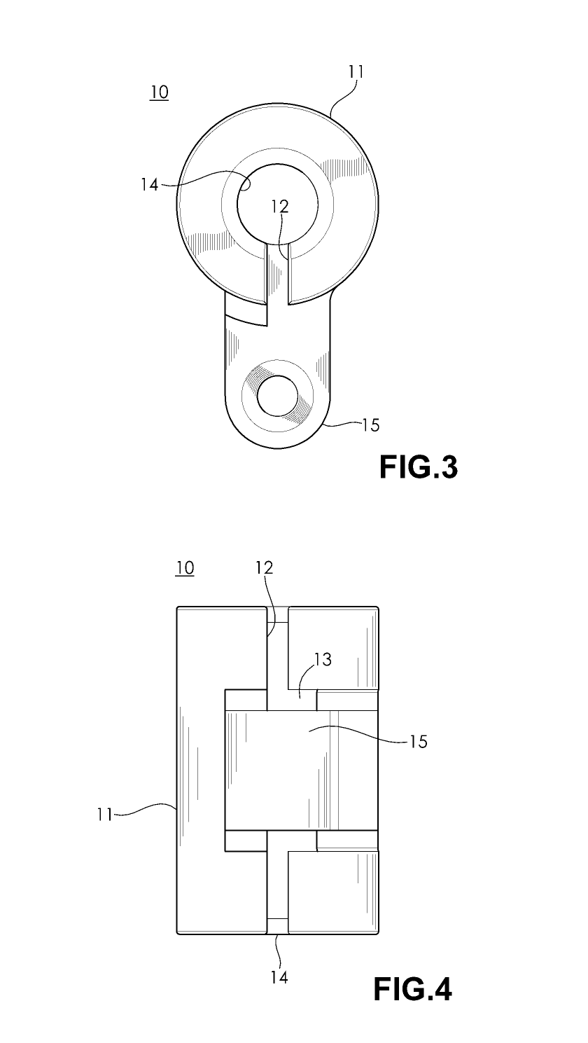

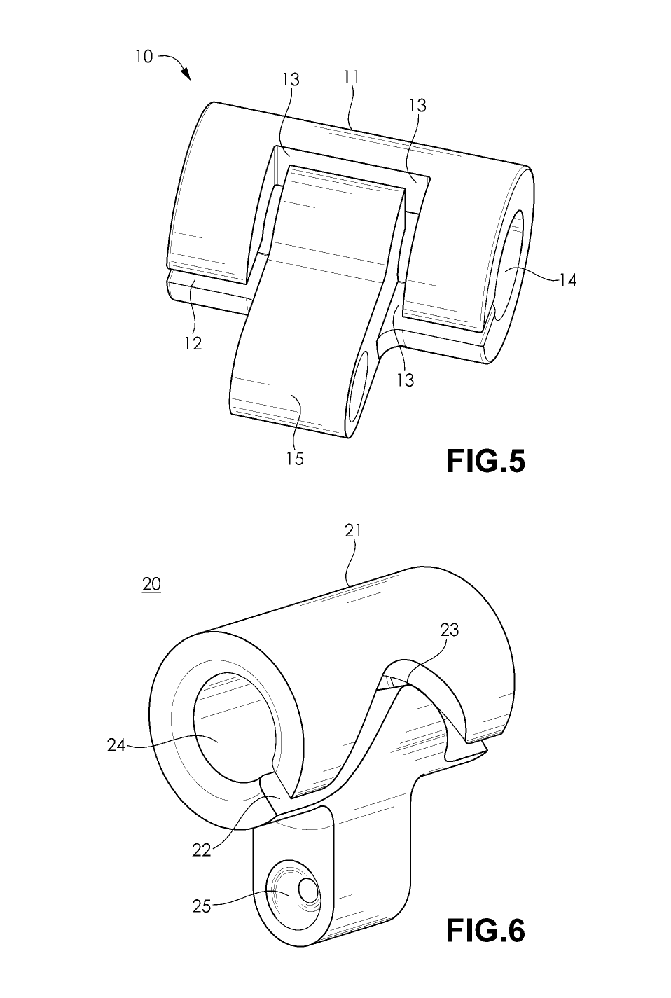

Turning now to FIGS. 1-5, an exemplary embodiment of the present invention is shown. The embodiment shows a fish finder apparatus 10 comprised of a body portion 11 with an exterior channel 12 formed from the use of four right angles 13. The exterior channel 12 allows for the passage of fishing line or other filamentous material through the exterior channel 12 into the interior channel 14. The embodiment shown in FIGS. 1-5 is further comprised of the optional component mounting section 15.

Turning now to FIG. 6, an alternate embodiment of the present invention is shown. The embodiment shows a fish finder apparatus 20 comprised of a body portion 21 with an exterior channel 22 formed from the use of a v shaped channel. The exterior channel 22 allows for the passage of fishing line or other filamentous material through the exterior channel 22 into the interior channel 24. The embodiment shown in FIG. 6 is further comprised of the optional component mounting section 25.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A fish finder apparatus, said fish finder apparatus comprising:
a body portion;
an exterior channel formed in said body portion, wherein said exterior channel runs the entire length of the body portion and said exterior channel is formed from one or more bends;
an interior channel formed in said body portion, wherein said interior channel runs the entire length of the body portion and forms a hollow center within said body portion,
wherein said exterior channel is connected to said interior channel and allows for a filamentous material to be inserted through said exterior channel and received into said interior channel.

2. The fish finder apparatus of claim 1, further comprising an optional component mounting section.

3. The fish finder apparatus of claim 2, wherein said optional component mounting section is configured to receive one or more components thereupon.

4. The fish finder apparatus of claim 1, wherein said one or more bends are comprised of 90 degree turns.

5. The fish finder apparatus of claim 1, wherein said one or more bends are comprised of one or more v shape bends.

6. The fish finder apparatus of claim 1, wherein said one or more bends are comprised are configured to prevent the filamentous material from passing through said exterior channel when said filamentous material is pulled taught.

7. The fish finder apparatus of claim 1, wherein said one or more bends are configured to allow the insertion and removal of said filamentous material through said exterior channel when said filamentous material is not being pulled taught.

8. The fish finder apparatus of claim 1, wherein said filamentous material is fishing line.

9. The fish finder apparatus of of claim 1, wherein said filamentous material may be removed from said interior channel without being damaged.
